(19) United States
(12) Patent Application Publication
(10) Pub. No.: US 2026/0022853 A1
(43) Pub. Date: Jan. 22, 2026

(54) SYSTEM FOR PREDICTING AND DETECTING MOLD GROWTH

(71) Applicant: Blue Ridge Venture Enterprises, Inc., Greenville, SC (US)

(72) Inventors: Christopher L. Davidson, Greer, SC (US); Benjamin Arnette Lagrange, Greer, SC (US)

(73) Assignee: Blue Ridge Venture Enterprises, Inc., Greenville, SC (US)

(21) Appl. No.: 19/234,389

(22) Filed: Jun. 11, 2025

Related U.S. Application Data
(60) Provisional application No. 63/672,317, filed on Jul. 17, 2024.

(51) Int. Cl. F24F 11/64; F24F 11/52; F24F 110/10; F24F 110/20; F24F 110/66; G01N 27/27; G01N 27/407

(52) U.S. Cl. CPC F24F 11/64; F24F 11/52; G01N 27/27; G01N 27/407; F24F 2110/10; F24F 2110/20; F24F 2110/66

(57) ABSTRACT

The present disclosure provides a system for detecting and predicting mold growth comprising a housing having at least one air intake passage defined in the housing; a first sensor disposed in said housing and in fluid communication with the air intake passage, the first sensor being capable of determining the temperature and humidity of the surrounding air; a database containing a plurality of mold growth predication algorithms, each being associated with a predefined temperature range; a computer system in communication with the first sensor and being adapted to receive from the first sensor a temperature reading and a humidity reading; retrieve from the database one of the mold growth prediction algorithms that is associated with the predefined temperature range in which the temperature reading falls; input into the retrieved mold prediction algorithm the humidity reading and calculate a value representing the number of days until mold growth occurs; and create a user notification representing a risk level associated with the likelihood of mold growth occurring.

### CROSS-REFERENCE TO RELATED APPLICATIONS

This application claims priority from U.S. Provisional Patent Application No. 63/672,317, filed Jul. 17, 2024, which is hereby incorporated by reference in its entirety.

### BACKGROUND

### 1) Field Of The Invention

The present disclosure relates to systems for monitoring and analyzing indoor air quality, and more particularly to a system for predicting and detecting mold growth by measuring environmental conditions and analyzing volatile organic compounds in the air.

### 2) Description of Related Art

It is generally accepted that indoor air quality is approximately 10 times worse than outdoor air quality. The pollutants that decrease indoor air quality often emanate from out of sight locations like attics, crawlspaces, HVAC systems and behind walls. These are the areas where mold growth can go undetected. By the time a homeowner notices the smell typically associated with mold, it is largely too late in that the amount of mold growth is likely to be substantial and likely to require costly remediation and/or repair.

There are two common situations that routinely lead to undetected mold growth. The first situation deals with the installation and/or use of an oversized HVAC system. Often, HVAC installation companies use a “rule of thumb” that the AC unit should be sized such that it has 1 ton cooling capacity for every 600 square feet of the home to be cooled. This rule of thumb does not account for many other characteristics that are typically involved in calculating the proper heat load and thus the proper size of the AC Unit. Thus, this rule of thumb often results in the installation of an oversized AC unit. The oversized unit reaches the desired temperature much quicker than a properly sized AC unit causing the oversized unit to shut off more quickly, thus reducing the amount of dehumidification of the indoor air. This causes the relative humidity of the air inside the home to remain higher than it would with a properly sized AC unit, thus creating an environment that is more likely to promote and/or accommodate mold growth. This is especially problematic in warm humid climates such as the Southeastern portion of the United States.

Another situation that often creates an environment that can foster mold growth is where the residents of the home are elderly. Many seniors prefer the set point of their thermostat to be higher than younger people—sometimes at 80 F or higher. The unintended consequence of a thermostat set at 80 F is that much less dehumidification is achieved inside the home, because the air conditioner runs less often. This is especially problematic in humid environments such as Southeastern region of the U.S. Allowing the relative humidity inside to stay above 60% is very likely to result in mold growth.

Most homeowners will not recognize this as a problem until mold spores begin to appear in more visible areas of the home such as on HVAC vents, window blinds or the like. By the time mold becomes visible, it has been growing in less visible areas such as crawl spaces, attics and/or the air duct systems running throughout the house. What is worse is that when the mold spores infiltrate the air ducts, those mold spores are circulated throughout the home.

It would be advantageous if homeowners could detect mold growth at a very early stage so that proper remediation can occur before the mold begins to spread to larger areas.

It would be advantageous if homeowners could detect environmental conditions that are likely to promote mold growth so that such conditions could be addressed before mold begins to grow.

It would be advantageous if homeowners were able to determine how likely that mold would grow in the detected conditions and the likely timeframe in which mold would likely start to grow so that the homeowners could determine the severity of the problem and the time in which the problem needed to be addressed.

It is therefore an object of the present invention to provide a system capable of detecting mold favorable conditions as well as at an early stage of growth.

It is another object of the present invention to provide a system capable of detecting environmental conditions that are likely to promote or accelerate mold growth and to predict the length of time before mold growth is likely to occur in the detected environmental conditions.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one embodiment the present invention is a system for detecting and predicting mold growth comprising a housing having at least one air intake passage defined in the housing; a first sensor disposed in said housing and in fluid communication with the air intake passage, the first sensor being capable of determining the temperature and humidity of the surrounding air; a database containing a plurality of mold growth predication algorithms, each being associated with a predefined temperature range; a computer system in communication with the first sensor and being adapted to: receive from the first sensor a temperature reading and a humidity reading; retrieve from the database one of the mold growth prediction algorithms that is associated with the predefined temperature range in which the temperature reading falls; calculate according to the mold prediction algorithm and the humidity reading a value representing the number of days until mold growth occurs; and, create a user notification representing a risk level associated with the likelihood of mold growth occurring.

In another embodiment, the present invention is a system for predicting and detecting the presence of mold, comprising: a housing having at least one air intake passage defined in the housing; a first sensor disposed in said housing and in fluid communication with the air intake passage, the first sensor being capable of detecting the concentration of volatile organic compounds given off by mold; a computer system in communication with the first sensor and adapted to: receive a first air sample from the first sensor, wherein the air sample contains volatile organic compounds emitted by mold; analyze the concentration of the volatile organic compounds contained in the first air sample to create a digital fingerprint of the volatile organic compounds, wherein the digital fingerprint includes a threshold concentration level of the volatile organic compounds, which if exceeded indicates the presence of mold; associate the digital fingerprint with the presence of mold; receive a second air sample from the first sensor; analyze the concentration of volatile organic compounds contained in the second air sample; compare the concentration of volatile organic compounds contained in the second air sample to the digital fingerprint; determine whether the concentration of volatile organic compounds contained in the second air sample exceeds a threshold concentration level of the digital fingerprint; and create a user notification representing the presence of mold

The foregoing general description of the illustrative embodiments and the following detailed description thereof are merely exemplary aspects of the teachings of this disclosure and are not restrictive.

### BRIEF DESCRIPTION OF FIGURES

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 illustrates a cutaway view of a sensor system installed within a return plenum, according to aspects of the present disclosure.

FIG. 2 shows a perspective view of the sensor system, according to an embodiment.

FIG. 3 depicts another perspective view of the sensor system, according to aspects of the present disclosure.

FIG. 4 illustrates a schematic diagram of a system for predicting and detecting mold growth, according to an embodiment.

FIG. 5A shows a graphical user interface displayed on a mobile device, according to aspects of the present disclosure.

FIG. 5B depicts another graphical user interface displaying environmental measurements and indicators, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present invention is a system for detecting and predicting mold growth by measuring and detecting characteristics of the ambient environment such as temperature, humidity and the presence of gases such as volatile organic compounds (VOCs) and volatile sulfur compounds (VSCs) in the air. The system can analyze the characteristics to both detect the presence of mold (mVOCs) within the environment and to predict the likelihood that mold will begin to grow in the detected environmental conditions and/or characteristics

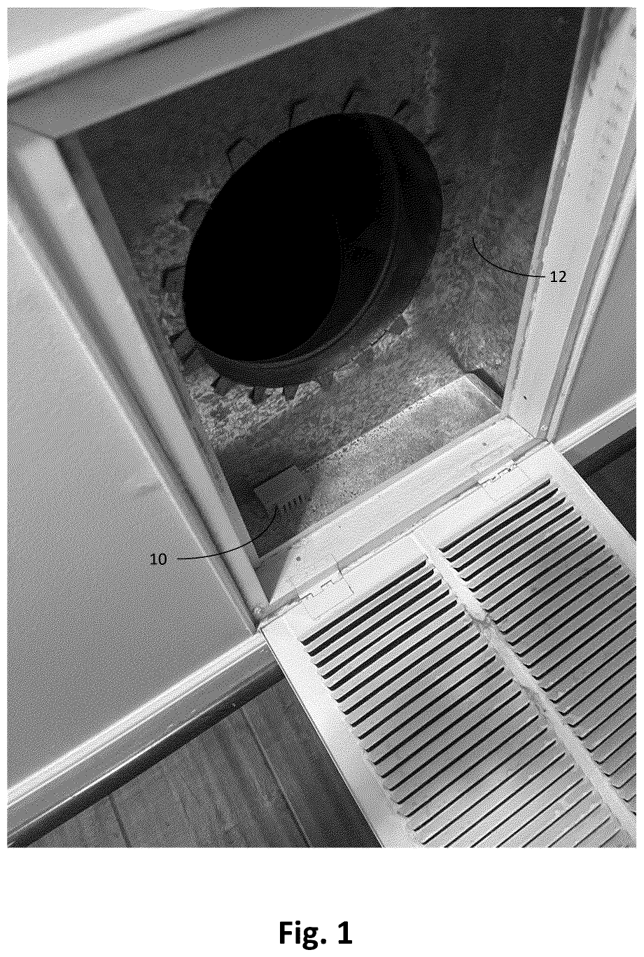

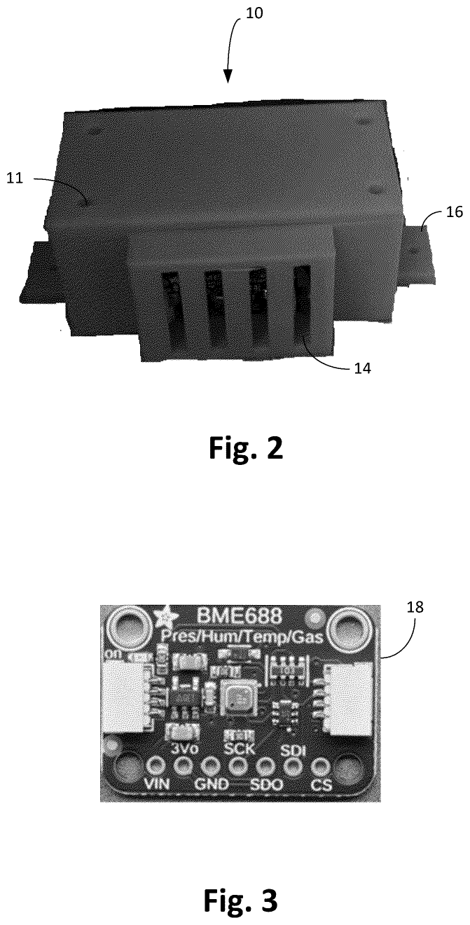

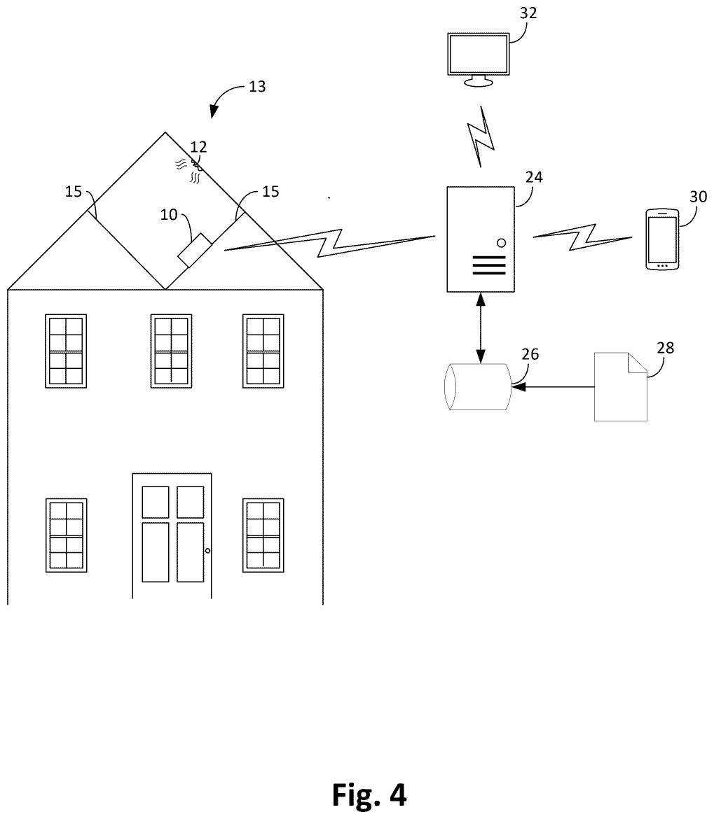

With reference to the drawings, the invention will now be described in more detail. Referring now to FIGS. 1-4, an embodiment of the sensor system 10 has been installed inside of a HVAC return plenum 12. As can be seen in FIG. 2, the sensor system includes a housing 11. The housing includes a plurality of air intake passages 14 defined therein as well as a plurality of attachment tabs 16 that allow the sensor system to be secured to a structure within the home by use of screws or the like (not shown). The air intake passages place an environmental sensor 18 that is disposed within the housing in fluid communication with the surrounding air. As shown in FIGS. 1-2, when the plenum pulls air from the home back to the HVAC's air handler (not shown), the air is drawn into the air intake passage 116.

The sensors can detect the temperature, humidity and presence and concentrations of gases in the surrounding air such as VOCs, VSCs, carbon monoxide, carbon dioxide, and hydrogen. The gas sensor included in the sensor system could be a semiconductor and/or metal oxide based gas sensor that detects gas concentrations by measuring changes in the electrical conductivity of the metal oxide surface (such as SnO2) as the gas is absorbed into the surface; electromechanical gas sensor that gas concentrations by oxidizing or reducing the gas at an electrode and measuring the resultant current; non-dispersive infrared gas sensor uses an infrared light source and an infrared detector to measure gas concentration based on absorption specific wavelengths of infrared light; photo-ionization detector uses ultraviolet light to ionize gases, measuring the current generated by these ions to determine gas concentration; thermal conductivity gas sensor that uses thermistors or thermal conductors placed in a bridge circuit to assess changes in thermal conductivity caused by different gases in the surrounding environment; capacitance-based gas sensor that detects changes in the capacitance caused by the dielectric constant changes of a gas absorbed on the sensor's coating; acoustic-based gas sensor that measures variations in the speed of sound in a gas mixture; calorimetric gas sensors that measures the heat change caused by a chemical reaction between the target gas and a reagent; and/or magnetic gas sensor that measures the change in the magnetic properties of a magnetic material when in the presence of certain gases, such as oxygen, to gauge gas concentration.

The sensor system 10 can be placed in various locations within a home where mold growth is common but often overlooked, such as an attic or a crawlspace. The ability to place the sensor system in various locations around a house may promote early detection and identification of potential mold growth locations for several reasons. By positioning sensors in multiple areas, the system may provide a more complete picture of environmental conditions throughout the entire home. This may allow for detection of localized issues that could be missed by a single centralized sensor.

Reading from multiple sensors placed in various locations throughout a home can assist with the determination of mold location in several ways. By comparing readings from different sensors, the system may create a spatial map of environmental conditions across the home. Areas with consistently higher humidity or temperature readings may indicate potential mold growth zones. Multiple sensors allow for the detection of environmental gradients. For example, a gradual increase in humidity readings from one room to another may suggest a moisture source and potential mold risk in a specific direction. Different areas of a home may have distinct microclimates. Multiple sensors can help identify these localized environments, such as poorly ventilated closets or damp basements, where conditions may be more conducive to mold growth. Data from multiple sensors may be compared to establish baseline conditions for different areas of the home. Deviations from these baselines in specific locations may indicate changes that could lead to mold growth. By analyzing readings from sensors in different rooms, the system may infer air flow patterns within the home. This information can help predict how mold spores might spread if present in a particular location. Multiple sensors may reveal how different areas of the home respond to seasonal changes. Some locations may become more prone to mold growth during certain times of the year. Sensors placed near HVAC vents and returns may help evaluate the effectiveness of the climate control system in different areas, potentially identifying zones where poor air circulation may contribute to mold risk. If multiple sensors detect a sudden increase in humidity, comparing the timing and magnitude of these changes across different locations may help pinpoint the source of moisture intrusion. For sensors capable of detecting mold-related volatile organic compounds (VOCs), comparing VOC levels across different locations may help identify areas where mold is actively growing. Long-term data from multiple sensors may reveal trends in environmental conditions specific to certain areas of the home, allowing for more accurate predictions of where mold is likely to develop over time.

By monitoring conditions in various locations, the system may detect subtle changes in temperature, humidity, or VOC levels that precede visible mold growth. This early warning may allow homeowners to address issues before mold becomes established. Sensors placed in less visible areas like wall cavities or behind appliances may detect moisture or environmental conditions conducive to mold growth in spaces that are not easily observable during visual inspections. By analyzing data from multiple locations, the system may provide a more nuanced risk assessment, potentially prioritizing areas that require immediate attention or preventive measures. Multiple data points from various locations may enhance the overall accuracy of mold growth predictions by accounting for spatial variations in environmental conditions throughout the home.

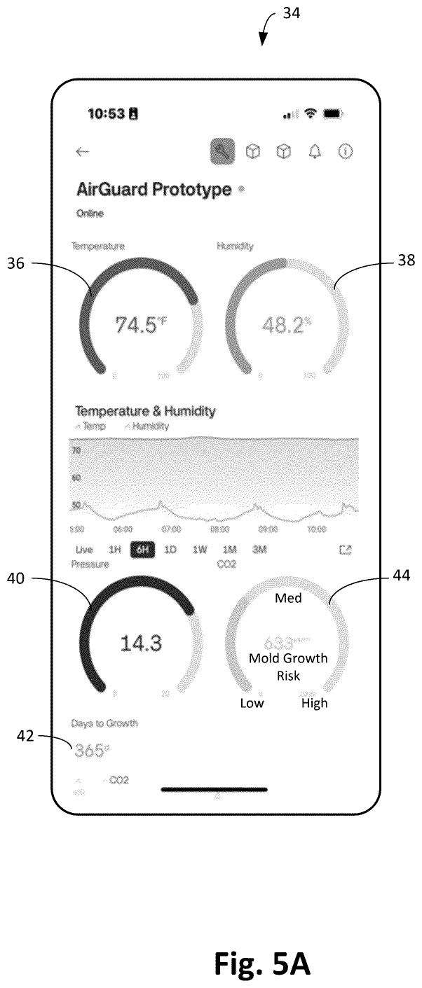

As shown in FIG. 4, sensor system 10 can be placed in the attic 13 by using the attachment tabs 16 to attach the system to a structural element 15 such as a roof rafter, joist or other structural component. Once in place, the ambient air may contact the sensor 16 by way of the air passages 14. The sensor system 10 may then detect the environmental factors, such as temperature, humidity, pressure and the presence and concentration of gases. Of particular importance is the detection of VOCs, mVOCs and/or VSCs associated with the presence of mold 17. Once the sensor has detected the environmental characteristic in question, such as temperature, humidity, pressure and/or presence and concentration of gases, the sensor can then convert these readings into digital values so that they may be transmitted to and analyzed by computer system 24.

To predict the likelihood of mold growth within the attic, the sensor system 10 may transmit to the computer system 24 digital values representing the temperature and relative humidity readings for the attic. These readings and/or digital values may be transmitted through any electronic communications that are generally known such as wired, wireless or cloud-based communications. The computer system 24 is in communication with a database 26 containing a plurality of mold growth prediction algorithms 28, each of which is associated with a predefined temperature range. These algorithms use the temperature and humidity readings to predict the likelihood that mold growth will occur in the environmental conditions detected by the sensor system. Below is Table 1 showing the algorithms for a range of temperatures that are most likely to be encountered within a home.

TABLE 1

| Temperature (° F.) | Model (x = HUMIDITY) |
|---|---|
| <65 | y = 904115e−0.136x |
| 65-69 | y = 3E+07e−0.18x |
| 70-74 | y = 2E+09e−0.233x |
| 75-79 | y = 1E+10e−0.265x |
| 80-84 | y = 2E+07e−0.172x |
| 85-89 | y = 1E+10e−0.257x |

In these algorithms, x represents the humidity reading received from the sensor system and y represents the number of days until mold growth is predicted to occur. Upon receiving from the sensor system 10 the temperature and humidity readings and/or digital values representing those readings, the computer system 24 may retrieve from the database 26 the algorithm that is associated with the temperature range in which the temperature reading falls. Once the correct algorithm is retrieved, the computer system may use the humidity reading to calculate the number of days until mold is predicted to grow in the environmental conditions detected (e.g. the temperature and humidity).

Once the days to mold growth is calculated, the computer system may create a user alert and/or notification representing a risk level that mold growth will occur. In one embodiment, the risk level notification could be selected from High, Medium and Low where High is associated with a mold growth prediction of less than 30 days, Medium is associated with a mold growth prediction of between 30-90 days and Low is associated with a mold growth prediction of more than 90 days. In alternate embodiments, different user alerts and/or risk notifications could be used and associated with any predefined range of days to growth predictions.

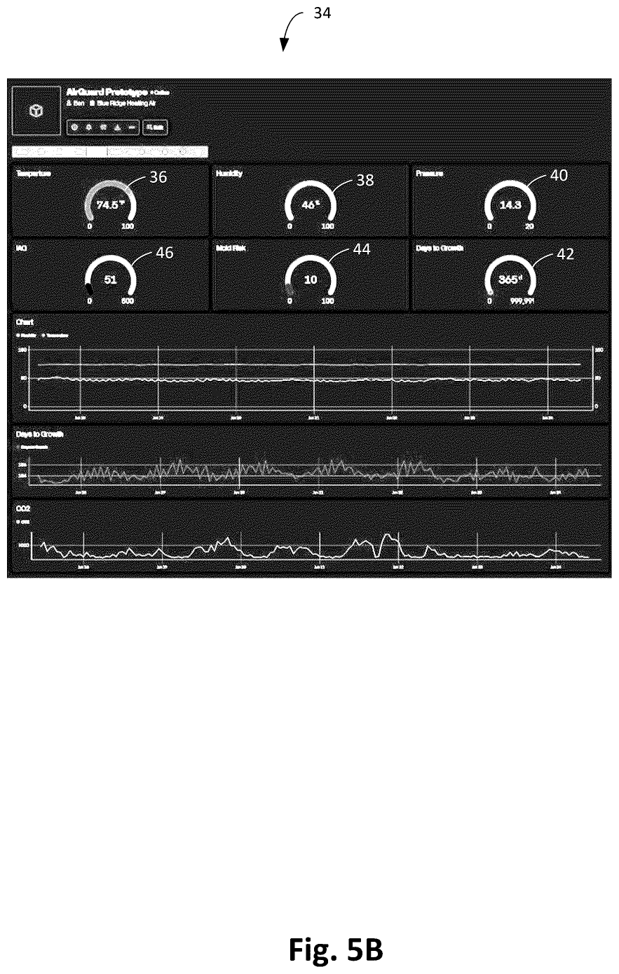

Referring now to FIGS. 5-6, the computer system 24 can be in communication with a graphical user interface 34 that is accessible by a second computing system such as a mobile device 30 and/or computer 32 associated with the homeowner. The graphical user interface 34 can provide a temperature reading 36, a humidity reading 38, a pressure reading 40, a days to mold growth prediction 42, a user risk notification 44 and an overall indoor air quality reading 46.

To detect the presence of mold growth (as opposed to predicting future mold growth), the sensor system detects and analyzes gases in the surrounding air to determine whether VOCs and/or VSCs that are typically associated with mold and/or bacterial growth are present and if so, in what concentrations. Using methods generally known in the art, the sensor detects the presence and concentration of each type of gas contained in the air entering though the air intake passages, creates a digital value representing the presence and/or concentration of each of the gases and transmits that digital value to the computer system. The computer system can use the digital values to create a digital fingerprint that is unique to the particular gas and/or mixture of gases. The computer system must be taught to associate the digital fingerprint with the gas mixture of interest. To teach the sensor to detect the presence of mold, for example, the sensor can be exposed to an area where mold growth is known to be present. Ideally, the sensor would be exposed to a significant source of mold growth so that the mVOCs, VOCs and/or VSCs would be highly concentrated. Once the computer system creates a digital fingerprint of the gases given off by the mold, the fingerprint can then be associated with mold growth or presence. To minimize the number of false positives, the sensor should also be exposed to “fresh” air that is known to be free of any pollutants, including mVOCs, VOCs and/or VSCs. The digital fingerprint created for this sample can be associated with “fresh” or “healthy” air.

When teaching the sensor to identify mold and to associate a digital fingerprint with the presence of mold, it is advantageous to expose the sensor to each type of mold that may be encountered in the geographic area in which it would be used. For example, in the Southern United States, two types of mold are common: Aspergillus/Penicillium and Cladosporium. To expose the sensor to these two types of mold, the sensor should be placed in indoor test environments where concentrations of each type of mold is present, preferably in at least one indoor space where each type of mold is present separately and at least one indoor space where both types are present together. Then the sensor may be exposed to test environments where no such molds are present. Preferably, at least one environment would be an indoor space in which no mold is present, and one environment would be an outdoor space in which no mold is present.

During the teaching or training period, the sensor should be allowed to run at steady state in each test environment for sufficient time to collect an adequate sample size. Preferably, this steady-state run-time would be equal to or greater than 30 minutes. Preferably, the sensor would run for longer than 30 minutes so that the time it takes for the sensor to “ramp” could be excluded from the sample collection data.

Once these fingerprints are uploaded and/or communicated to the sensor, the sensor system will continuously receive air samples from the environment in which it is installed. With each sample, the sensor will create a digital fingerprint associated with the sample and compare that sample's fingerprint to the fingerprint associated with mold growth. If the sample's fingerprint is sufficiently similar to the mold growth fingerprint, the sensor will transmit an alert to the computer system, which can in turn alert the homeowner that mold is present. In one embodiment, the alert can be binary indicating either that mold was detected or that it was not. In alternate embodiments, the alert can provide the homeowner an alert as to the likely amount of mold growth based upon the concentrations of the mVOCs, VOCs and/or VSCs detected in the subsequent environmental air samples.

This same sensor system may use the same process to detect the presence of other pollutants such as carbon monoxide, carbon dioxide or flammable gases such as propane or other natural gases.

In at least one embodiment, the sensor system can also detect changes in the pressure of the air flowing within an HVAC system. The sensor and/or computer system can be programmed to detect when the pressure exerted by an air current drops outside of an acceptable range. An air current pressure that falls below the acceptable pressure range can indicate that it is time to change one or more air filters within the HVAC system.

One such sensor that provides the capabilities discussed herein is the Bosch BME-688 environmental sensor. In one embodiment, the Bosch BME-688 sensor is connected to a processer, such as an ESP32-S3 Feather that is capable of transmitting information from the sensor to the computer system 24.

The system may aggregate sensor data from multiple homes by securely collecting readings from sensor systems 10 installed in various locations and associating them with anonymized location identifiers. This data collection process may utilize the wireless or cloud-based communication capabilities of the computer system 24 to transmit sensor readings to a centralized database. To associate sensor data with specific locations, the system may use general location information such as zip codes or neighborhood designations rather than precise GPS coordinates or street addresses. This approach may help maintain user privacy while still allowing for meaningful geographic comparisons. The computer system 24 may implement data anonymization techniques to further protect homeowner privacy when aggregating and analyzing location-based data.

The graphical user interface 34 may be enhanced to enable comparisons between a user's home and aggregated data from nearby residences. This functionality may include displaying average temperature, humidity, and mold risk levels for the local area alongside the user's individual readings. The system may present these comparisons using color-coded maps or charts that highlight variations in environmental conditions across different neighborhoods.

By comparing data from nearby homes, users may determine if mold issues are localized to their specific residence or common to the broader area. For example, if a user's home shows elevated humidity levels compared to the neighborhood average, it may indicate a localized issue such as a plumbing leak. Conversely, if multiple homes in an area display similar environmental conditions conducive to mold growth, it may suggest a systemic problem related to regional climate patterns or shared infrastructure.

This comparative analysis may offer additional benefits such as identifying seasonal trends in mold risk factors across different geographic areas. The aggregated data may also be used to refine and improve the accuracy of the mold growth prediction algorithms 28 by incorporating a wider range of environmental data and outcomes. This expanded dataset may enhance the system's ability to provide early warnings and targeted recommendations for mold prevention and remediation strategies.

The system described herein addresses several problems that are not addressed by the current state of the technology. For example, the system addresses the problem of delayed detection of mold growth in hidden areas of homes. This system can be installed in typically overlooked locations like attics, crawlspaces, and HVAC systems to continuously monitor environmental conditions conducive to mold growth. By analyzing temperature, humidity, and the presence of mold-related VOCs, the system can detect mold at very early stages before it becomes visible or spreads extensively. Early detection of mold growth may allow homeowners to address the issue promptly, potentially reducing remediation costs and minimizing health risks associated with prolonged mold exposure.

The system can address the difficulty in predicting the likelihood and timeframe of potential mold growth by using a database of mold growth prediction algorithms that use real-time temperature and humidity data to calculate the number of days until mold growth is likely to occur. This allows homeowners to understand the severity of the risk and the urgency of addressing environmental conditions.

The system can address the current lack of continuous monitoring and timely alerts for mold risk with the current system. This system provides real-time monitoring through a graphical user interface accessible via mobile devices or computers. It generates user alerts and notifications representing risk levels (High, Medium, Low) based on environmental conditions and predicted time to mold growth, enabling proactive measures and allowing for early detection and remediation.

The system can also detect the potential of inefficient HVAC systems that have sub optimal operations that can lead to conditions favorable for mold growth. The system can detect changes in air pressure within HVAC systems, potentially indicating when air filters need replacement. This helps maintain optimal HVAC performance, which is important for controlling humidity levels and preventing conditions that promote mold growth. Preventive measures for mold growth may be preferred to remediation as they can potentially save homeowners significant time, money, and health risks associated with extensive mold infestations, while also preserving the structural integrity of the building and avoiding the need for costly and disruptive remediation processes.

The system can also assist with distinguishing between different types of air quality issues, a feature that is absent in the current technology. The system uses advanced gas sensors and can use machine learning techniques to create digital fingerprints of various air pollutants, including different types of mold, carbon monoxide, and other gases. This allows for specific identification of mold species and other air quality threats beyond just mold.

The system may utilize machine learning techniques to continuously improve the performance of the sensors and enhance the accuracy of mold detection and prediction. As the sensors collect more data over time, machine learning algorithms may be applied to refine the digital fingerprints associated with various environmental conditions and mold species. In some aspects, the computer system 24 may implement supervised learning algorithms that analyze labeled data sets from known mold growth scenarios. This process may allow the system to better distinguish between different types of mold and improve its ability to detect mold at earlier stages of growth.

Unsupervised learning techniques may also be employed to identify patterns and anomalies in the sensor data that human programmers might not anticipate. This approach may help uncover new indicators of potential mold growth or air quality issues. The system may incorporate federated learning techniques, where improvements made by individual sensor systems can be shared across the network without compromising user privacy. In this approach, the local computer system 24 may train its models on the data collected from its sensors, then share only the updated model parameters with a central server. The central server may aggregate these updates from multiple locations to create an improved global model. This global model may then be distributed back to individual sensor systems, allowing each unit to benefit from the collective learning of the entire network. As a result, sensors in one location may improve their performance based on data collected by sensors in other geographic areas, without the need to directly share raw sensor data.

The system may also implement transfer learning techniques, where knowledge gained from detecting one type of mold or environmental condition can be applied to improve detection of other related conditions. This approach may be particularly useful when deploying sensors to new geographic areas with different prevalent mold species. Adaptive learning algorithms may be used to allow the system to adjust its detection and prediction models based on local environmental factors. For example, sensors in humid coastal areas may fine-tune their models differently than those in arid inland regions. Machine learning improvements may extend beyond mold detection to enhance other aspects of the system's performance. For instance, the system may learn to optimize its power consumption, adjust sampling frequencies based on detected risk levels, or improve the accuracy of its HVAC performance monitoring. By leveraging these machine learning techniques, the system may continually evolve and improve its performance across all installed locations, providing users with increasingly accurate and timely information about mold risks and air quality issues.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

What is claimed is:

1. A computerized system for detecting and predicting mold growth, comprising:
a housing containing a sensor in fluid communication with the air intake passage defined in the housing, wherein the sensor is configured to measure temperature and humidity of a surrounding air;
a computer system having a plurality of mold growth prediction algorithms, each algorithm associated with a predefined temperature range; and
wherein the computer system is in communication with the sensor and configured to:
receive temperature and humidity readings from the sensor,
determine, using one of a mold growth prediction algorithm, a predicted time until mold growth according to the algorithm and the humidity reading, and
generate a user notification representing a mold growth risk level based on the predicted time.

2. The computerized system of claim 1, wherein the sensor is further configured to detect volatile organic compounds (VOCs) associated with mold growth.

3. The computerized system of claim 2, wherein the computer system is further configured to analyze concentrations of VOCs detected by the sensor to detect mold growth.

4. The computerized system of claim 1, wherein the mold growth risk level is selected from high, medium, and low based on the predicted time until mold growth.

5. The computerized system of claim 4, wherein:
the high risk level corresponds to a predicted time of less than 30 days,
the medium risk level corresponds to a predicted time between 30 and 90 days, and
the low risk level corresponds to a predicted time greater than 90 days.

6. The computerized system of claim 1, further comprising attachment mechanisms configured to secure the housing to a surface within a building.

7. The computerized system of claim 6, wherein the structure is selected from the group consisting of: an HVAC return plenum, an attic structural element, and a crawl space structural element.

8. A networked system for environmental detection related to mold growth, comprising:
a plurality of sensor units, each sensor unit comprising a housing with an air intake passage and an environmental sensor configured to detect volatile organic compounds (VOCs) associated with mold;
a central computer system in communication with the plurality of sensor units; and
a database accessible by the central computer system, wherein the central computer system is configured to:
receive air sample data from the sensor units,
analyze the air sample data to create digital fingerprints of VOC concentrations,
compare the digital fingerprints to stored mold-associated VOC profiles, and
generate alerts when the comparison indicates a presence of mold-associated VOCs.

9. The networked system of claim 8, wherein each sensor unit further comprises a temperature sensor and a humidity sensor.

10. The networked system of claim 9, wherein the central computer system is further configured to:
receive temperature and humidity data from the sensor units,
retrieve a mold growth prediction algorithm based on the temperature data, and
calculate a predicted time until mold growth using the algorithm and humidity data.

11. The networked system of claim 10, wherein the central computer system is further configured to generate a mold growth risk level notification based on the calculated predicted time until mold growth.

12. The networked system of claim 11, wherein the mold growth risk level is selected from high, medium, and low, with:
high risk corresponding to a predicted time of less than 30 days,
medium risk corresponding to a predicted time between 30 and 90 days, and
low risk corresponding to a predicted time greater than 90 days.

13. The networked system of claim 8, wherein the sensor units are configured to be installed in locations selected from the group consisting of: HVAC return plenums, attics, and crawl spaces.

14. The networked system of claim 13, wherein the central computer system is further configured to aggregate data from multiple sensor units to identify patterns in environmental conditions across different locations within a building.

15. A sensor system for predicting and detecting mold growth, comprising:
a housing attachable to a structure within a building;
an environmental sensor disposed within the housing and configured to measure temperature and humidity;
a processor coupled to the environmental sensor; and
a wireless communication module coupled to the processor,
wherein the processor is configured to:
analyze environmental measurements from the sensor to predict a likelihood of mold growth,
detect changes in air pressure indicative of HVAC system performance, and
transmit, via the wireless communication module, environmental data and mold growth predictions to a remote device.

16. The sensor system of claim 15, wherein the environmental sensor further comprises a volatile organic compound (VOC) sensor configured to detect mold-associated VOCs.

17. The sensor system of claim 16, wherein the processor is further configured to:
analyze VOC measurements from the VOC sensor to create a digital fingerprint associated with mold presence, and
compare subsequent VOC measurements to the digital fingerprint to detect mold growth.

18. The sensor system of claim 15, wherein the processor is further configured to:
retrieve a mold growth prediction algorithm based on the measured temperature, and
calculate a predicted time until mold growth using the algorithm and the measured humidity.

19. The sensor system of claim 18, wherein the processor is further configured to generate a mold growth risk level notification based on the calculated predicted time until mold growth, wherein:
a high risk level corresponds to a predicted time of less than 30 days,
a medium risk level corresponds to a predicted time between 30 and 90 days, and
a low risk level corresponds to a predicted time greater than 90 days.

20. The sensor system of claim 19, wherein the housing is configured to be attached to a structure selected from the group consisting of: an HVAC return plenum, an attic structural element, and a crawl space structural element.
